(19) United States
(12) Patent Application Publication
(10) Pub. No.: US 2009/0032145 A1
(43) Pub. Date: Feb. 5, 2009

(54) Method of forming a multilayer, corrosion-resistant finish

(75) Inventors: Leonard L. Diaddario, JR., Charlotte, NC (US); Michael Marzano, Concord, OH (US); Steven K. Brennan, Matthews, NC (US); Michael Shone, Matthews, NC (US)

Correspondence Address: MOORE & VAN ALLEN PLLC, P.O. BOX 13706, Research Triangle Park, NC, 27709, US

(73) Assignee: Pavco, Inc., Charlotte, NC (US)

(21) Appl. No.: 12/214,867

(22) Filed: Jun. 23, 2008

Related U.S. Application Data
(60) Provisional application No. 61/045,775, filed on Apr. 17, 2008.
(60) Provisional application No. 60/945,483, filed on Jun. 21, 2007.

(51) Int. Cl. C23C 22/05; C09D 1/00

(52) U.S. Cl. 148/264; 148/23; 148/243

(57) ABSTRACT

ABSTRACT OF THE DISCLOSURE The present invention is directed to a high protection coating process that is particularly useful for substrates in need of corrosion protection. The invention provides methods of applying a non-chrome passivating layer or conversion coating to a substrate and optionally, a secondary conversion or passivating layer to the non-chrome passivating layer or conversion coating, and articles having said coatings thereon.

### CROSS REFERENCE TO RELATED APPLICATIONS

This is a non-provisional application claiming priority to U.S. Provisional Patent Application No. 60/945,483 for “Method of Forming a Multilayer, Corrosion-Resistant Finish” filed on Jun. 21, 2007 in the name of Leonard L. Diaddario Jr. et al., and U.S. Provisional Patent Application No. 61/045,775 for “Method of Forming a Multilayer, Corrosion-Resistant Finish” filed on Apr. 17, 2008 in the name of Leonard L. Diaddario Jr. et al., both of which are hereby incorporated herein by reference in their entirety.

### FIELD

The present invention generally relates to an anti-corrosion or corrosion-resistant finish and method(s) of forming said finish. More particularly, the present invention relates to a corrosion-resistant finish primarily for use in industries including, but not limited to, the automobile and fastener industries, which finish comprises multiple layers, including a non-chrome passivating or conversion coating layer, and optionally, a secondary conversion or passivating layer.

### DESCRIPTION OF THE RELATED ART

It is well known to those skilled in the art to employ a conversion or passivation coating on the surface of galvanized steel to impart improved corrosion resistance of bare and painted metal, improve adhesion of additional coatings such as paint or other finishes, and for aesthetic purposes. For example, see Corrosion, L. L. Sheir, R. A. Jarman, G. T. Burstein, Eds. (3^{rd} Edition, Butterworth-Heineinann Ltd, Oxford, 1994), vol. 2, chapter 15.3.

In general, conversion coatings have been prepared using hexavalent chromate (chromium (VI)). That said, the National Institute for Occupational Safety and Health (NIOSH) considers all chromium (VI) compounds to be potential occupational carcinogens. Accordingly, to minimize the pollution effect of chromates discharged into rivers and waterways by such processes, conventional chromate conversion processes require extensive water treatment procedures to control their discharge. In addition, the disposal of the solid sludge from such waste treatment procedures is a significant problem.

Hexavalent chromium-free treatments have been developed utilizing trivalent chromium. Unfortunately, many of the trivalent chromium conversion coating compositions require the presence of an oxidizing agent as an essential ingredient, which may lead to some conversion of the trivalent chromium to hexavalent chromium. That said, the present inventors have provided a high protection, trivalent chromium coating composition that is particularly useful as a conversion coating, wherein said composition is substantially free of hexavalent chromium and components that may facilitate the conversion of chromium (III) to chromium (VI) (see, e.g., U.S. patent application Ser. No. 11/420,570 in the name of Leonard L. Diaddario Jr., which is hereby incorporated by reference in its entirety).

There are non-chrome treatments for forming passivation coatings on metals, but these are generally unsatisfactory for enhancing the corrosion resistance of the underlying metal, particularly when the treated substrate is subjected to a humid environment. Moreover, many of the non-chrome coatings are not aesthetically pleasing, especially the thicker black coatings. Accordingly, non-chrome passivating layers, e.g., a phosphate or molybdate-black layer, are often sealed with an additional conversion coating to affect corrosion resistance as well as improve adhesion and the aesthetics of the product. Traditionally, the secondary conversion coating has been organic in nature and as such, has been problematic to work with because of thread and/or head recess fill in the end product, e.g., fasteners, and/or the processing equipment.

Accordingly, an inorganic secondary conversion coating is disclosed that provides corrosion resistance to the underlying metal, is aesthetically pleasing, and does not detrimentally accumulate on the product and/or the processing equipment.

In addition, a method of manufacturing a multilayer metal product designed to meet extended corrosion properties required by the automotive and fastener industries is disclosed. Preferably, the manufactured product includes (i) a non-chrome passivating or conversion coating and optionally (ii) a secondary conversion or passivating layer, such that the product is able to substantially withstand the salt spray test to white corrosion.

### SUMMARY OF THE INVENTION

The present invention generally relates to a process of manufacturing a material in need of corrosion protection. More specifically, a process of applying multiple coatings to a metal surface is described, wherein said multiple coatings include (i) a non-chrome passivating layer or conversion coating and optionally, (ii) a secondary conversion or passivating layer. Preferably, the article including the non-chrome passivating or conversion coating and the optional secondary conversion or passivating layer can substantially withstand the salt spray test to white corrosion.

In one aspect, an inorganic composition is described, said inorganic composition comprising at least one chromium (III) salt, and at least one additional component selected from the group consisting of at least one metal other than chromium, at least one anion, at least one chelating ligand, a pH buffering agent, at least one corrosion enhancement agent, at least one rheology modifier, water, and combinations thereof, wherein the inorganic composition is useful as a conversion coating or passivating layer to provide corrosion resistance to a material in need thereof. Preferably, the inorganic composition includes chromium (III) phosphate, either added as chromium (III) phosphate per se or chemically formed therein using a chromium-containing compound and a phosphate-containing compound.

In another aspect, a method of manufacturing a corrosion-resistant article is described, said method comprising: coating a substrate with a non-chrome conversion coating or passivating layer, wherein the corrosion-resistant article includes the substrate and the non-chrome conversion coating or passivating layer.

In another aspect, a method of manufacturing a corrosion-resistant article is described, said method comprising: coating a substrate with a non-chrome conversion coating or passivating layer; and coating the non-chrome conversion coating or passivating layer with a secondary conversion or passivating layer, wherein the corrosion-resistant article includes the substrate, the non-chrome conversion coating or passivating layer and the secondary conversion or passivating layer.

In yet another aspect, a method of manufacturing a corrosion-resistant article is described, said method comprising: plating a substrate with zinc or a zinc alloy to produce a plated substrate; and coating the plated substrate with a non-chrome conversion coating or passivating layer, wherein the corrosion-resistant article includes the plated substrate and the non-chrome conversion coating or passivating layer. Preferably, zinc or zinc alloy is electrodeposited onto the substrate.

In yet another aspect, a method of manufacturing a corrosion-resistant article is described, said method comprising: plating a substrate with zinc or a zinc alloy to produce a plated substrate; coating the plated substrate with a non-chrome conversion coating or passivating layer; and coating the non-chrome conversion coating or passivating layer with a secondary conversion or passivating layer, wherein the corrosion-resistant article includes the plated substrate, the non-chrome conversion coating or passivating layer and the secondary conversion or passivating layer. Preferably, zinc or zinc alloy is electrodeposited onto the substrate.

In still another aspect, a method of manufacturing a corrosion-resistant article is described, said method comprising coating die cast metal with a non-chrome conversion coating or passivating layer, wherein the corrosion-resistant article includes the die cast substrate and the non-chrome conversion coating or passivating layer. Preferably, the die cast metal comprises zinc.

In still another aspect, a method of manufacturing a corrosion-resistant article is described, said method comprising: coating die cast metal with a non-chrome conversion coating or passivating layer; and coating the non-chrome conversion coating or passivating layer with a secondary conversion or passivating layer, wherein the corrosion-resistant article includes the die cast substrate, the non-chrome conversion coating or passivating layer and the secondary conversion or passivating layer. Preferably, the die cast metal comprises zinc.

Another aspect relates to a method of manufacturing a corrosion-resistant article, said method comprising galvanizing a substrate with zinc or a zinc alloy to produce a galvanized substrate and coating the galvanized substrate with a non-chrome conversion coating or passivating layer, wherein the corrosion-resistant article includes the galvanized substrate and the non-chrome conversion coating or passivating layer. The galvanized substrate may be stainless steel.

Another aspect relates to a method of manufacturing a corrosion-resistant article, said method comprising: galvanizing a substrate with zinc or a zinc alloy to produce a galvanized substrate; coating the galvanized substrate with a non-chrome conversion coating or passivating layer; and coating the non-chrome conversion coating or passivating layer with a secondary conversion or passivating layer, wherein the corrosion-resistant article includes the galvanized substrate, the non-chrome conversion coating or passivating layer and the secondary conversion or passivating layer. The galvanized substrate may be stainless steel.

In still another aspect, a method of manufacturing a corrosion-resistant article is described, said method comprising exposing a substrate to an oxidizing agent to oxidize the substrate to produce an oxidized substrate and coating the oxidized substrate with a non-chrome conversion coating or passivating layer, wherein the corrosion-resistant article includes the substrate and the non-chrome conversion coating or passivating layer. Preferably, the substrate is preferably a zinc or zinc alloy plated substrate, a zinc die cast substrate or a galvanized substrate, e.g., stainless steel.

In still another aspect, a method of manufacturing a corrosion-resistant article is described, said method comprising: exposing a substrate to an oxidizing agent to oxidize the substrate to produce an oxidized substrate; coating the oxidized substrate with a non-chrome conversion coating or passivating layer; and coating the non-chrome conversion coating or passivating layer with a secondary conversion or passivating layer, wherein the corrosion-resistant article includes the substrate, the non-chrome conversion coating or passivating layer and the secondary conversion or passivating layer. Preferably, the substrate is preferably a zinc or zinc alloy plated substrate, a zinc die cast substrate or a galvanized substrate, e.g., stainless steel.

Still another aspect relates to an article comprising a substrate and a non-chrome conversion coating or passivating layer. Preferably, the substrate comprises at least one metal selected from the group consisting of iron, zinc, aluminum, cadmium, and alloys thereof, steel, stainless steel, and combinations thereof, and the non-chrome conversion coating or passivating layer comprises at least one species selected from the group consisting of molybdate, phosphate, iron, copper, titanium, titanates, vanadates, aluminates, cobalt, cerium, and combinations thereof.

Still another aspect relates to an article comprising a substrate, a non-chrome conversion coating or passivating layer, and secondary conversion or passivating layer. Preferably, the substrate comprises at least one metal selected from the group consisting of iron, zinc, aluminum, cadmium, and alloys thereof, steel, stainless steel, and combinations thereof, and the secondary conversion or passivating layer comprises chromium (III) ions.

In another aspect, a conversion coating composition is described, wherein said composition comprises iron (II) ions, iron (III) ions, vanadium (V) ions, nitrate ions, and water, wherein said conversion coating composition is useful for coating a substrate with a black conversion coating. The composition may further comprise at least one additional component selected from the group consisting of vanadium (III) ions, carboxylic acids, copper (II) ions, strong acids, and combinations thereof.

In still another aspect, a method of coating a substrate with a black conversion coating is described, said method comprising contacting the substrate with a black conversion coating for sufficient time and under sufficient conditions for the deposition of a layer of black conversion coating on said substrate, wherein said black conversion coating composition comprises iron (II) ions, iron (III) ions, vanadium (V) ions, nitrate ions, and water. The composition may further comprise at least one additional component selected from the group consisting of vanadium (III) ions, carboxylic acids, copper (II) ions, strong acids, and combinations thereof. A secondary conversion or passivating layer may be optionally applied onto the black conversion coating to produce an article including the substrate, the black conversion coating, and a secondary conversion or passivating layer.

Other aspects, features and advantages of the invention will be more fully apparent from the ensuing disclosure and appended claims.

### BRIEF DESCRIPTION OF THE FIGURES

FIG. 1 is an electron micrograph of a Zn substrate having a 3 micron layer of the black conversion coating of the invention thereon.

### DETAILED DESCRIPTION OF THE INVENTIONS AND PREFERRED EMBODIMENTS THEREOF

The present invention relates generally to the treatment of a substrate having a metal surface for improving the properties thereof, particularly the corrosion resistance of the substrate.

In various embodiments, the compositions and articles may be described herein in terms of being “substantially free” of certain compounds, elements, ions or other like components. Accordingly, as used herein, “substantially free” is intended to mean that the compound, element or other like component is present, at most, in only trace amounts (i.e., a concentration so minute that the presence of the compound, element, ion, or other like component will have no adverse affect on the desired properties of the coating). Preferably, “substantially free” indicates the specified compound, element, ion, or other like component is completely absent or is not present in any amount measurable by techniques generally used in the art.

As defined herein, a “non-chrome” or “chrome-free” passivating or conversion coating is substantially free of chromium, chromium salts and/or chromium ions. In other words, a non-chrome coating is substantially free of chromium (O), chromium (I), chromium (II), chromium (III), chromium (IV), chromium (V) and/or chromium (VI) ions and as such, will have no adverse health or environmental impact. Non-chrome coatings can be applied at various thicknesses and can provide varying levels of corrosion protection, as well as other properties.

As defined herein, the term “conversion coating” or “conversion treatment,” refers to a treatment of the surface of a substrate which causes the surface material to be chemically converted to a different material. The term “passivating layer” or “passivating treatment” refers to a treatment of the surface of a substrate to form a barrier layer to corrosive conditions on said surface but without a cohesive film forming a chemical bond between the surface and the passivating layer film.

As defined herein, the term “substrate” means a material having an exposed surface that can be cleaned and/or protected and/or modified with the intent of providing corrosion resistance. A substrate is not limited to any particular type of material, although in terms of applying a corrosion resistant coating, such substrates are typically metal and include at least one metal species selected from the group consisting of iron, zinc, aluminum, cadmium, tin and alloys thereof, steel, stainless steel, and combinations thereof. For example, the substrate could include die cast zinc. Alternatively, the substrate may include at least a second metal species deposited, e.g., electrodeposited, galvanized, etc., onto a first metal species, wherein the first metal species and the second metal species may be the same as or different from one another, and together form a plated substrate. It is to be understood that the term “substrate” is not meant to be limiting in any way and includes any substrate that is plated, cleaned, rinsed, or has at least one layer thereon.

As defined herein, an “article” corresponds to the material that includes a substrate and has been coated with the at least one layer and/or the surface of which has been converted, as described herein. For example, an article may include a substrate (plated or not), a non-chrome passivating layer or conversion coating, and optionally, a secondary conversion or passivating layer.

As defined herein, “corrosion-resistant” refers to an article (e.g., a substrate having a non-chrome passivating or conversion coating and optionally, a secondary conversion or passivating layer) that can substantially withstand the salt spray testing to white corrosion. It should be appreciated that a “corrosion resistant” article can be “corrosion free” immediately and for a time following the application of the non-chrome and optionally, secondary, conversion coating or passivating layer.

It is generally known in the art that passivating layers or conversion coatings can range from colorless to a very thin “blue-bright” finish to a very thick “olive-drab” or “black” finish. Blue-bright finishes are transparent with a slight blue tint and high luster. Such a finish not only imparts a corrosion-resistant coating to the surface of the substrate but also aesthetically enhances the substrate and articles made therefrom. Heavier chromate conversion coatings are considerably more protective than the bright finishes, but they do not meet the aesthetic criteria that are characteristic of the bright coatings. These heavier coatings are well-recognized by their yellow, bronze, olive-drab, or black finishes, which correspond in general order to increasing film thickness.

In one aspect, a method of manufacturing a corrosion-resistant article is described, said method comprising coating a substrate with a non-chrome conversion coating or passivating layer, wherein the corrosion-resistant article includes the substrate and the non-chrome conversion coating or passivating layer. It should be appreciated that the method of this aspect corresponds to the application of any non-chrome conversion coating regardless of what “color” or process of coating said “color” onto a substrate. For example, the non-chrome conversion coating or passivating layer may be colorless or colored, e.g., blue-bright, yellow, bronze, olive-drab, black, etc., as readily understood by one skilled in the art. Non-chrome layers include species selected from the group consisting of, molybdate, phosphate, iron, copper, titanium, titanates, vanadates, aluminates, cobalt, cerium, and combinations thereof. The non-chrome conversion coating or passivating layer can be applied to the substrate, plated substrate or article according to any method generally recognized in the art. In one embodiment, the non-chrome conversion coating or passivating layer is a black conversion coating.

In another aspect, a method of manufacturing a corrosion-resistant article is described, said method comprising coating a substrate with (i) a non-chrome conversion coating or passivating layer and (ii) a secondary conversion or passivating layer, wherein the corrosion-resistant article includes the substrate, the non-chrome conversion coating or passivating layer and the secondary conversion or passivating layer. It should be appreciated that the method of this aspect corresponds to the application of any non-chrome conversion coating regardless of what “color” or process of coating said “color” onto a substrate. For example, the non-chrome conversion coating or passivating layer may be colorless or colored, e.g., blue-bright, yellow, bronze, olive-drab, black, etc., as readily understood by one skilled in the art. The secondary conversion or passivating layer may be chrome-containing or non-chrome. Non-chrome layers include species selected from the group consisting of, molybdate, phosphate, iron, copper, titanium, titanates, vanadates, aluminates, cobalt, cerium, and combinations thereof. The non-chrome and secondary conversion coating or passivating layer can be applied to the substrate, plated substrate or article according to any method generally recognized in the art. In one embodiment, the non-chrome conversion coating or passivating layer is a black conversion coating.

In yet another aspect, a novel black non-chrome conversion coating and compositional bath for the deposition of said coating is described. It is to be appreciated by one skilled in the art that the novel black conversion coating of this aspect may be, but is not required to be, the non-chrome conversion coating or passivating layer described in the aforementioned methods of manufacturing a corrosion-resistant article. In one embodiment, the black conversion coating composition generally comprises iron (III) ions, iron (II) ions, vanadium (V) ions, and nitrate ions. In further embodiments, the black conversion coating composition further comprises at least one additional species selected from the group consisting of vanadium (III) ions, carboxylic acids, copper (II) ions, and combinations thereof. The mixture of the various types of ions, particularly in specified concentrations, is useful for forming a black conversion coating on a substrate having an exposed surface, thereby providing improved corrosion resistance and/or decorative appearances for the substrate. It should be generally understood that use of the term “black conversion coating composition” does not make any claim to the color of the composition but rather is used to consistently describe the composition that is used for the deposition of a black conversion coating.

According to certain embodiments of this aspect, the iron (III) to iron (II) ions are present in the black conversion coating composition in a specific ratio. For example, in one embodiment, a iron (III) to iron (II) ion weight ratio is initially provided in a range from about 1:1 to about 10:1, preferably about 3:1 to about 7:1, and most preferably about 4:1 to about 6:1. The iron (III) ion source and the iron (II) ion source are chosen from various salts of the metal. It is preferred that the iron (III) source and the iron (II) source not include components that could be detrimental to the properties of the black conversion coating composition. Non-limiting examples of metal salts that could be used in the invention include inorganic salts, such as nitrate salts, nitrite salts, chloride salts, bromide salts, iodide salts, sulfate salts, phosphate salts, carbonate salts, bicarbonate salts, perchlorate salts, chlorate salts, fluoride salts, hydroxide salts, and organic salts, such as acetate salts, formate salts, oxalate salts, and citrate salts, or any combination of the aforementioned salts. The respective salts of the iron (III) source and the iron (II) source may be the same as or different from one another.

Vanadium ions, preferably vanadium (V) ions, are added to the black conversion coating composition having a pH in a range from about 3 to about 7, preferably about 4 to about 6, and most preferably about 4.4 to about 5, such that vanadium (V) ions will convert to vanadium (III) ions to maintain a portion of the iron ions in the +3 oxidation state. The amount of vanadium (V) ions that should be added to the black conversion coating composition may be readily determined by one skilled in the art using a Pourbaix diagram knowing the pH values of the composition. The vanadium (V) ion source is chosen from various salts of the metal. It is preferred that the vanadium (V) source not include components that could be detrimental to the properties of the black conversion coating composition. Non-limiting examples of metal salts that could be used in the invention include inorganic salts, such as oxide salts, nitrate salts, nitrite salts, chloride salts, bromide salts, iodide salts, sulfate salts, phosphate salts, carbonate salts, bicarbonate salts, perchlorate salts, chlorate salts, fluoride salts, hydroxide salts, and organic salts, such as acetate salts, formate salts, oxalate salts, and citrate salts, or any combination of the aforementioned salts. Preferably, the vanadium (V) salt is an oxide salt. Although not wishing to be bound by theory, it is thought that when vanadium (V) is added to the black Fe³⁺/Fe²⁺conversion coating composition in the preferred pH range, a redox equilibrium is established such that the vanadium (V) reduces to vanadium (III) and the iron (II) is oxidized to the Fe³⁺state therefore maintaining some of the iron in the Fe³⁺state.

In a preferred embodiment of this aspect, the black conversion coating composition further includes at least one nitrate salt. Any source capable of providing a sufficient concentration of nitrate ions without introducing additional components that could be detrimental to the composition can be used. In one embodiment, NaNO₃ is used to provide nitrate ions to the composition. Other non-limiting examples of nitrate sources that could be used according to the invention include alkali metal nitrates (such as potassium nitrate), alkaline earth metal nitrates (such as magnesium nitrate), ammonium nitrate, and tetraalkylammonium nitrate, where the alkyl groups may be the same as or different from one another and may be C₁-C₆ groups (e.g., methyl, ethyl, propyl, butyl, pentyl, hexyl). In one embodiment, the cumulative nitrate to iron (III) ion weight ratio is provided in a range from about 1:1 to about 7:1, preferably about 2:1 to about 5:1, and most preferably about 2.5:1 to about 3.5:1.

In yet another preferred embodiment of this aspect, the black conversion coating composition further comprises at least one carboxylic acid, such as monocarboxylic acids, dicarboxylic acids, tricarboxylic acids, the carboxylate of said carboxylic acid, or combinations thereof. In a particularly preferred embodiment, the carboxylic acid includes acetic acid, lactic acid, formic acid, propanoic acid, malonic acid, malic acid, succinic acid, oxalic acid, citric acid, the carboxylate thereof, or combinations of any of the above. In one embodiment, the citrate to iron (III) ion weight ratio is provided in a range from about 1:1 to about 7:1, preferably about 1.5:1 to about 4:1, and most preferably about 2:1 to about 3:1.

In still another preferred embodiment of this aspect, the black conversion coating composition further comprises at least one copper (II) ion. The copper (II) ion source is chosen from various salts of the metal. It is preferred that the copper (II) source not include components that could be detrimental to the properties of the black conversion coating composition. Non-limiting examples of metal salts that could be used in the invention include inorganic salts, such as nitrate salts, nitrite salts, chloride salts, bromide salts, iodide salts, sulfate salts, phosphate salts, and organic salts, such as acetate salts, formate salts, oxalate salts, and citrate salts, or any combination of the aforementioned salts. Preferably, the copper (II) salt is copper sulfate pentahydrate.

The black conversion coating composition of this aspect can be prepared in a properly diluted form that is ready to use. Alternatively, the black conversion coating composition may be provided in a concentrated form that is diluted prior to application of the composition to the substrate. In one embodiment, a concentrate is provided wherein, upon proper dilution (such as with water), the diluted concentrate forms a black conversion coating composition as described herein. In another non-limiting example, a concentrate is diluted with water and a strong acid, for example hydrochloric acid or sulfuric acid, wherein the strong acid, e.g., HCl, is added to adjust the pH to within the preferred range. The present inventors surprisingly discovered that the process of plating the substrate with the black conversion coating may be faster or slower depending on the pH of black conversion coating composition, whereby the higher the pH, the slower the process. Although not wishing to be bound by theory, the strong acid, e.g., may ensure the smooth, uniform and continuous growth of the black conversion coating without a substantial amount of powder residue on the surface of the substrate.

In a particularly preferred embodiment of this aspect, the black conversion coating composition comprises, consists of, or consists essentially of iron (III) ions, iron (II) ions, vanadium (V) ions, vanadium (III) ions, nitrate ions, citrate ions, acetate ions, copper (II) ions, and water, and the pH is adjusted in a range from about 4.4 to about 5 using a strong acid such as HCl.

Of note, the black conversion coating composition described herein in this aspect is substantially devoid of chromium, molybdenum, and silver.

The black conversion coating composition is particularly useful in a method for applying a black conversion coating to a substrate (or plated substrate) with an exposed surface to provide the finished article with corrosion resistance and/or decorative appearances as described hereinabove. In one embodiment, the method comprises contacting the exposed surface of the substrate with a black conversion coating composition as described herein. For example, the application of the black conversion coating can be by spraying, dipping, immersing, rolling, or other similar methods. In one particular embodiment, the substrate is immersed in a bath comprising the black conversion coating composition.

The black conversion coating composition is also particularly useful for applying a black conversion coating on a substrate wherein the exposed surface of the substrate is plated with a metal coating by electrodeposition. In one particular embodiment, the exposed surface of the substrate is plated with zinc or a zinc alloy. Non-limiting examples of zinc alloys useful as plating the exposed surface of the substrate include ZnSn alloys, ZnNi alloys, ZnFe alloys, and ZnCo alloys. The substrate can be plated according to any plating method generally recognized in the art as being useful for plating zinc or zinc alloy. For example, the conversion coating, and method of application thereof, can be used in combination with plating techniques, such as cyanide, alkaline non-cyanide, sulfate-zinc, and chloride zinc plating methods.

The black conversion coating may be applied to the substrate at a temperature of at least about ambient temperature. In one preferred embodiment, the temperature of the black conversion coating composition during application to the substrate is elevated above ambient temperature. Such elevated temperature is particularly useful in that it has been found to improve the ultimate corrosion resistance of the overall article. In certain embodiments, the temperature during application of the black conversion coating composition is between about 20° C. and about 60° C., preferably about 30° C. and about 40° C. The period of time during which the black conversion coating composition is applied can vary depending upon the other method parameters, such as the method of applying the black conversion coating, the dilution of the composition, the pH of the composition, and the temperature of the composition. Preferably, the time of application is in a range from about 1 sec to about 60 sec, preferably about 10 sec to about 50 sec, and most preferably about 15 sec to about 45 sec.

In yet another aspect, a black conversion coating is described, wherein the coating is substantially devoid of chromium, nickel, molybdenum, silver or organic compounds. The coating may be deposited using the black conversion coating composition described herein using the method described herein.

In another aspect, a secondary conversion or passivating layer that provides corrosion-resistance to the substrate and the composition for deposition of same is described. As previously described, the secondary conversion or passivating layer may be optionally coated on a non-chrome conversion coating or passivating layer. Preferably, the secondary conversion or passivating layer includes a chromium (III) ion in the form of a salt. The secondary conversion or passivating layer composition includes at least one chromium (III) ion and at least one additional species selected from the group consisting of at least one metal other than chromium, at least one anion, at least one chelating ligand, a pH buffering agent, at least one corrosion enhancement agent, at least one rheology modifier, water, and combinations thereof. In a particularly preferred embodiment, the secondary conversion or passivating layer and the secondary conversion or passivating layer composition is substantially free of chromium (VI) ions.

The chromium (III) and additional metals can be provided through sources such as metal salts. While sulfate, chloride, phosphate, and nitrate salts are particularly useful, any chromium (III) salt could be provided that does not contribute components that could be detrimental to the anti-corrosive properties of the secondary conversion or passivating layer composition. Non-limiting examples of metal salts that could be used in the invention include phosphate salts, nitrate salts, nitrite salts, sulfate salts, sulfite salts, acetate salts, carbonate salts, bicarbonate salts, perchlorate salts, chlorate salts, oxalate salts, fluoride salts, chloride salts, bromide salts, iodide salts, citrate salts, hydroxide salts, oxide salts, etc. Most preferably, the secondary conversion or passivating layer includes chromium (III) phosphate, either added as chromium (III) phosphate per se or chemically formed therein using a chromium-containing compound and a phosphate-containing compound.

The secondary conversion or passivating layer may contain at least one metal in addition to chromium (III) to enhance the corrosion protection of the composition, wherein said at least one metal is selected from the group consisting of lithium, sodium, magnesium, aluminum, potassium, calcium, titanium, vanadium, manganese, iron, cobalt, nickel, copper, zinc, strontium, zirconium, molybdenum, tin, tungsten, cesium, barium, and combinations thereof. These metals preferably are in the form of a metal salt. Non-limiting examples of metal salts that could be used in the invention include phosphate salts, nitrate salts, nitrite salts, sulfate salts, sulfite salts, acetate salts, carbonate salts, bicarbonate salts, perchlorate salts, chlorate salts, oxalate salts, fluoride salts, chloride salts, bromide salts, iodide salts, citrate salts, hydroxide salts, oxide salts, etc.

In one embodiment of this aspect, the secondary conversion or passivating layer composition includes at least one chelating ligand capable of forming complexes with chromium (III) and any additional metal ions utilized in the composition. Preferably, the at least one chelating ligand is selected from the group consisting of dicarboxylic acids, tricarboxylic acids, hydroxycarboxylic acids, aminocarboxylic acids, polyphosphates, phosphonates, polyamines, salts thereof, derivatives thereof, and combinations thereof.

In certain embodiments of this aspect, it is beneficial for the secondary conversion or passivating layer composition to comprise further ionic components that, in solution, enhance or improve the corrosion resistance ability of the composition. For enhanced corrosion protection, the secondary conversion or passivating layer composition additionally may contain at least one of silicate, fluorosilicates, colloidal silica, borate, and fluoroborates.

In another embodiment of this aspect, the secondary conversion or passivating layer composition may contain at least one rheology modifier to assist in forming a coating of more uniform thickness. Suitable rheology modifiers include polysaccharides, methylcellulose, hydroxyethylcellulose, hydroxypropylcellulose, polyvinyl pyrrolidone (PVP), polyvinyl alcohols, guar gums, and xanthan gums.

In one embodiment of this aspect, the secondary conversion or passivating layer composition comprises, consists of, or consists essentially of chromium (III) ions, zinc ions, citrate ions, phosphate ions, and chloride ions. In another embodiment, the secondary conversion or passivating layer composition comprises, consists of, or consists essentially of chromium (III) ions, zinc ions, cobalt ions, citrate ions, phosphate ions, and chloride ions. In still another embodiment, the secondary conversion or passivating layer composition comprises, consists of, or consists essentially of chromium (III) ions, cobalt ions, citrate ions, phosphate ions, and sulfate ions.

According to certain embodiments of this aspect, the chromium (III) ions are present in a preferable concentration range. Preferably, the chromium (III) ions are present in a concentration range of about 0.04 moles/L to about 0.18 moles/L. More preferably, the chromium (III) ions are present in a concentration range of about 0.07 moles/L to about 0.14 moles/L.

According to another embodiment of this aspect, the cobalt (II) ions are present in a preferable concentration range of about 0.01 moles/L to about 0.05 moles/L. More preferably, the cobalt (II) ions are present in a concentration range of about 0.02 moles/L to about 0.04 moles/L.

According to still yet another embodiment of this aspect, the zinc (II) ions are present in a preferable concentration range of about 0 moles/L to about 0.25 moles/L.

In one embodiment of this aspect, a source of citrate ions is provided such that a preferred concentration of about 0.04 mole/L to about 0.20 moles/L is achieved. More preferably, the citrate ions are present in a concentration range of about 0.07 moles/L to about 0.15 moles/L.

Preferably, according to one embodiment of this aspect, a source of phosphate ions is provided such that the composition comprises at least 0.01 moles/L to about 0.5 moles/L. More preferably, the phosphate ions are provided in a concentration range of about 0.15 moles/L to about 0.30 moles/L.

In yet another embodiment of this aspect, a source of sulfate ions is provided such that the composition consists of about 0 moles/L to about 1 mole/L. More preferably, sulfate ions are provided in a concentration range of about 0.2 moles/L to about 0.9 moles/L.

The secondary conversion or passivating layer composition can be prepared in a properly diluted form that is ready to use. Alternatively, the secondary conversion or passivating layer composition may be provided in a concentrated form that is diluted prior to application of the composition to the article. In one embodiment of the invention, a concentrate is provided where, upon proper dilution (such as with water), the diluted concentrate forms a secondary conversion or passivating layer composition as described herein. According to one non-limiting example, a concentrate is provided wherein upon dilution of 20% by volume (i.e., 20 parts concentrate to 80 parts diluent), a secondary conversion or passivating layer composition is formed comprising about 0.04 moles/L to 0.18 moles/L of chromium (III) ions, about 0.01 moles/L to 0.05 moles/L of cobalt (II) ions, about 0 moles/L to 0.25 moles/L zinc (II) ions, about 0.01 moles/L to 0.5 moles/L phosphate ions, about 0.04 mole/L to 0.20 moles/L citrate ions, and about 0 moles/L to 1 mole/L sulfate ions.

The secondary conversion or passivating layer may be applied using rack or barrel operations. The equipment for said operations preferably includes a tank, or a tank lining, made from a material inert to the secondary conversion or passivating layer composition, such as polypropylene, polyvinyl chloride (PVC), Koroseal, or the like. In one particular embodiment, water is first added to the tank. Then, the appropriate amount of the concentrated form of the secondary conversion or passivating layer composition is added and mixed.

Application of the secondary conversion or passivating layer to the article is preferably carried out under specified conditions. For example, in one embodiment, the pH of the bath containing the secondary conversion or passivating layer composition is maintained within a certain range. Preferably, the pH of the secondary conversion or passivating layer composition is acidic (i.e., less than about 7, and more preferably, less than about 6). In specific embodiments, the pH of the secondary conversion or passivating layer composition is about 1 to about 6, preferably about 2 to about 4.

The secondary conversion or passivating layer may be applied to the non-chrome conversion coating or passivating layer (or optionally the non-chrome black conversion coating) at a temperature of at least about ambient temperature. In one preferred embodiment, the temperature of the secondary conversion or passivating layer composition during application to the article is elevated above ambient temperature. Such elevated temperature is particularly useful in that it has been found to improve the ultimate corrosion resistance of the overall article. In certain embodiments, the temperature during application of the secondary conversion or passivating layer composition is between about 20° C. and about 70° C., preferably about 30° C. and about 60° C., and most preferably about 40° C. and about 60° C. The period of time during which the secondary conversion or passivating layer composition is applied can vary depending upon the other method parameters, such as the method of applying the secondary conversion or passivating layer, e.g., barrel or rack, the dilution of the composition, and the temperature of the composition. Preferably, the time of application is in a range from about 1 sec to about 60 sec, preferably about 2 sec to about 40 sec, and most preferably about 3 sec to about 25 sec.

Advantageously, the secondary conversion or passivating layer described herein does not fill thread or head recesses in the article and does not build-up on racks. Accordingly, the secondary conversion or passivating layer may be applied using a barrel or rack operation and thus most manufacturing facilities may be easily adapted to incorporate said secondary conversion or passivating layer into the manufacturing procedure.

Additional processing, before and/or after coating the substrate with the non-chrome conversion coating or passivating layer and the optional secondary conversion or passivating layer, is contemplated. For example, prior to coating the substrate with the non-chrome conversion coating or passivating layer, a second metal species, e.g., zinc-containing compound, may be deposited onto a first metal species to form a plated substrate. Zinc-containing compounds that may be deposited include zinc and zinc alloys including, but not limited to, ZnSn alloys, ZnNi alloys, ZnFe alloys, ZnCo alloys, and combinations thereof. The substrate can be plated according to any plating method generally recognized in the art as being useful for plating zinc or zinc alloy, for example, cyanide, alkaline non-cyanide, sulfate-zinc, and chloride zinc plating methods. Alternatively, the second metal species is applied to the first metal species using galvanization processes known in the art. For example, the substrate may be stainless steel.

In addition, the substrate may be rinsed, dried, treated with acid, and/or oxidized during the process of manufacturing the corrosion-resistant article. For example, in an exemplary metal treatment operation, an iron-containing alloy, such as steel, may be prepared for plating by cleaning the substrate in immersion alkaline cleaners with and/or without current applied with the parts anodic and, optionally, acid treating the substrate. Preferably, the substrate is rinsed after the cleaning and optional acid treating steps. The substrate is then electroplated with zinc or zinc alloy. After plating, the plated substrate is rinsed, optionally exposed to a mild inorganic acid (such as nitric acid, hydrochloric or sulfuric acid), oxidizing agent, and/or alkaline immersion with an oxidizer present to oxidize the surface, and rinsed again. Preferably, the surface is oxidized prior to additional processing. The non-chrome conversion coating or passivating layer is then applied and the plated substrate with the non-chrome conversion coating or passivating layer applied thereto is rinsed. When present, the secondary conversion or passivating layer is then applied (or optionally applied when the non-chrome conversion coating is a black conversion coating) according to the invention, and the article dried. It is to be appreciated by one skilled in the art that the method of manufacturing a corrosion-resistant article may include only some of the above steps, in addition to the step of applying the non-chrome conversion coating or passivating layer and optional secondary conversion or passivating layer.

Optionally, the layered article may be exposed to a dye, such as the Mordant family of diazo dyes, without degrading the corrosion protection of the coating(s).

The corrosion resistance provided by the non-chrome and inorganic coatings of the invention are easily evaluated by salt spray (or salt fog) testing performed according to the standards of the American Society for Testing and Materials (ASTM) designation B 117-03. Importantly, the corrosion resistance provided by the processes of the invention may be evaluated by other known testing methods and are intended to provide coatings capable of meeting or exceeding performance requirements that may be described in terms of one or more different testing methods.

According to ASTM B 117-03, the testing apparatus consists of a fog chamber, a salt solution reservoir, a supply of a suitably conditioned compressed air, and atomizing nozzles. Using the apparatus, a salt solution comprised of about 5 parts by weight (pbw) NaCl in 95 pbw water is sprayed onto specimens for continuous prolonged periods to cause corrosion. Depending upon the specimen used, time to corrosion can be evaluated.

Corrosion testing may be performed on zinc plated steel specimens to which the non-chrome conversion coating or passivating layer and optional secondary conversion or passivating layer has been applied. The onset of white salt corrosion products may be documented in the test, wherein said white salts indicate corrosion of the underlying zinc plating. In one embodiment, an article having the non-chrome conversion coating or passivating layer and optional secondary conversion or passivating layer of the invention applied thereto may be characterized in that the coatings provide anti-corrosion protection such that when subjected to a salt spray according to ASTM testing method B 117-03 described above, the article is substantially resistant to formation of white salts.

In yet another aspect, a kit is described, said kit comprising, in one or more containers, the non-chrome conversion coating or passivating layer composition, optionally the secondary conversion or passivating layer composition, and optionally the composition for plating the substrate, and wherein the kit is adapted to form the respective compositions for providing corrosion-resistance to a material in need thereof. Importantly, the non-chrome conversion coating or passivating layer composition may be provided in one or more containers wherein the components are mixed for use or activated at the facility by the user. Similarly, the secondary conversion or passivating layer composition may be provided in one or more containers wherein the components are mixed for use or activated at the facility by the user. In addition, the composition for plating the substrate may be provided in one or more containers wherein the components are mixed for use or activated at the facility by the user.

In a preferred embodiment, the present invention relates to a method of manufacturing a corrosion-resistant article, said method comprising: coating a substrate with a black non-chrome conversion coating as described herein; and optionally coating the black non-chrome conversion coating with an secondary conversion or passivating layer as described herein, wherein the corrosion-resistant article includes the substrate, the black non-chrome conversion coating and optionally, the secondary conversion or passivating layer.

In another preferred embodiment, the present invention relates to a method of manufacturing a corrosion-resistant article, said method comprising: plating a substrate with zinc or a zinc alloy to produce a plated substrate; coating the plated substrate with a black conversion coating; and optionally coating the black conversion coating with an secondary conversion or passivating layer, wherein the corrosion-resistant article includes the plated substrate, the black conversion coating and optionally, the secondary conversion or passivating layer. Preferably, the zinc or zinc alloy is electrodeposited onto the substrate.

In yet another preferred embodiment, the present invention relates to a method of manufacturing a corrosion-resistant article, said method comprising: coating a die cast substrate with a non-chrome layer; and optionally coating the non-chrome layer with a secondary conversion or passivating layer, wherein the corrosion-resistant article includes the die cast substrate, the non-chrome layer and optionally, the secondary conversion or passivating layer. Importantly, the non-chrome layer may be blue-bright, yellow, bronze, olive-drab, or black and the die cast substrate includes zinc.

In another preferred embodiment, the present invention relates to a method of manufacturing a corrosion-resistant article, said method comprising: galvanizing a substrate with zinc or a zinc alloy to produce a galvanized substrate; coating the galvanized substrate with a non-chrome conversion coating or passivating layer; and optionally coating the non-chrome conversion coating or passivating layer with a secondary conversion or passivating layer, wherein the corrosion-resistant article includes the galvanized substrate, the non-chrome conversion coating or passivating layer and optionally, the secondary conversion or passivating layer. Importantly, the non-chrome conversion coating or passivating layer may be blue-bright, yellow, bronze, olive-drab, or black.

In still another preferred embodiment, the present invention relates to a method of manufacturing a corrosion-resistant article, said method comprising: exposing a substrate to an oxidizing agent to oxidize the substrate to produce an oxidized substrate; coating the oxidized substrate with a non-chrome layer; and optionally coating the non-chrome layer with a secondary conversion or passivating layer, wherein the corrosion-resistant article includes the substrate, the non-chrome layer and optionally, the secondary conversion or passivating layer. Preferably, the non-chrome layer is blue-bright, yellow, bronze, olive-drab, or black and the substrate is preferably a zinc or zinc alloy plated substrate, a zinc die cast substrate or a galvanized substrate, e.g., stainless steel.

In a particularly preferred embodiment, an article comprising a substrate, a non-chrome conversion coating or passivating layer, and a secondary conversion or passivating layer is described. Preferably, the substrate comprises at least one metal selected from the group consisting of iron, zinc, aluminum, cadmium, and alloys thereof, steel, stainless steel, and combinations thereof, and the secondary conversion or passivating layer comprises chromium (III) ions.

Although not wishing to be bound by theory, it is thought that during the deposition of the secondary conversion or passivating layer onto the non-chrome conversion coating, the corrosion protection is enhanced, as well as the aesthetics of the article. In addition, it is thought that the non-chrome conversion coating dissolves slightly in the secondary conversion or passivating layer composition and the dissolved materials may redeposit with the secondary conversion or passivating layer from said composition.

The features and advantages of the invention are more fully shown by the illustrative examples discussed below.

### EXAMPLE 1

A black conversion coating concentrate was formulated, wherein said concentrate comprised 2.5 mL of 10 wt. % citric acid, 0.1 g of FeSO₄, 2.0 mL of 20 wt. % NaNO₃, 2.0 mL of 10 wt. % V₂O₅, 5.0 mL of 10 wt. % FeCl₃.6H₂O, 1.9 g of sodium acetate, 0.3 mL of 10 wt. % CuSO₄.5H₂O and water to bring the total volume to 15 mL. A working solution was obtained by diluting the concentrate to a total of 100 mL with water and concentrated HCl to the appropriate pH. The initial pH was 5.01, which was adjusted to 4.62 for coating purposes.

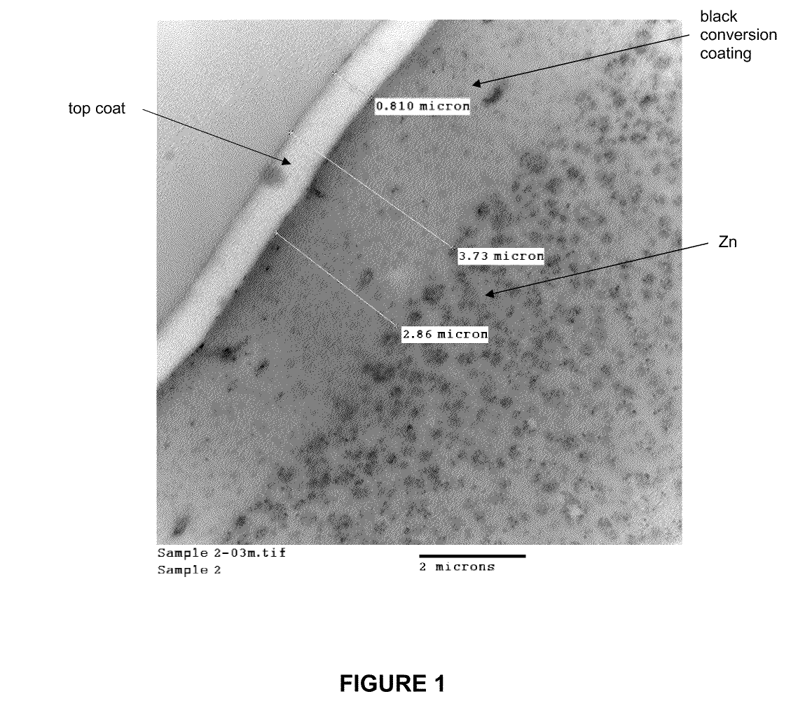

A substrate including Zn was dipped in the black conversion coating composition at 33° C. for 40 sec, which resulted in the formation of the black conversion coating on the surface of the Zn, rinsed with water, dried, dipped in a secondary conversion or passivating layer composition, and rinsed with water. An SEM of the layers, shown in FIG. 1, reveals that about 3 microns of black film was deposited along with a layer of the secondary conversion or passivating layer (about 0.81 microns). Notably, the micrograph shows exceptional lateral uniformity, possibly due to the higher pH and in-situ activation caused by the HCl. Moreover, there is a low concentration, by volume, of iron in the film which extends the life of the conversion coating working solution. Because of the pH and ions in solution, destructive complexes are negligible and the working solution is stable for up to three months and can be readily replenished during processing for the deposition of a substantial number of parts.

Although not wishing to be bound by theory, the present inventors believe that the black conversion coating includes two different, mostly amorphous, phases. One is related to ZnO and the other is related to Zn ferrite, wherein the ferrite, being an inverse spinel, has two different sites for iron. It is believed that the best blackening is achieved when both the Fe²⁺ and the Fe³⁺ ions are present in the ferrite compound. In addition, analysis of the secondary conversion or passivating layer revealed that some iron is present therein, suggesting that some of the black conversion coating dissolved in the secondary conversion or passivating layer composition and redeposited from the supersaturated solution as part of the secondary conversion or passivating layer.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

What is claimed is:

1. A method of manufacturing a corrosion-resistant article, said method comprising:
coating a substrate with a non-chrome layer using a non-chrome layer composition under first coating conditions
wherein the corrosion-resistant article includes the substrate and the non-chrome layer.

2. The method of claim 1, wherein the non-chrome layer is colorless, blue-bright, yellow, bronze, olive-drab, or black.

3. The method of claim 1, further comprising coating the non-chrome layer with an secondary conversion or passivating layer using a secondary conversion or passivating layer composition under second coating conditions.

4. The method of claim 3, wherein the secondary conversion or passivating layer composition comprises at least one chromium (III) salt, and at least one additional component selected from the group consisting of at least one metal other than chromium, at least one anion, at least one chelating ligand, a pH buffering agent, at least one corrosion enhancement agent, at least one rheology modifier, water, and combinations thereof.

5. The method of claim 4, wherein the secondary conversion or passivating layer composition further comprises water.

6. The method of claim 4, wherein the secondary conversion or passivating layer composition further comprises at least one metal other than chromium, wherein said metal comprises a species selected from the group consisting of lithium, sodium, magnesium, aluminum, potassium, calcium, titanium, vanadium, manganese, iron, cobalt, nickel, copper, zinc, strontium, zirconium, molybdenum, tin, tungsten, cesium, barium, and combinations thereof.

7. The method of claim 4, wherein the secondary conversion or passivating layer composition further comprises at least one chelating ligand selected from the group consisting of dicarboxylic acids, tricarboxylic acids, hydroxycarboxylic acids, aminocarboxylic acids, polyphosphates, phosphonates, polyamines, salts thereof, derivatives thereof, and combinations thereof.

8. The method of claim 3, wherein the pH of the secondary conversion or passivating layer composition is in a range from about 1 to about 6.

9. The method of claim 3, wherein the secondary coating conditions comprise at least one condition selected from the group consisting of: temperature in a range from about 20° C. to about 70° C.; time in a range from about 1 sec to about 60 sec; and combinations thereof.

10. The method of claim 1, wherein the substrate comprises at least one metal selected from the group consisting of iron, zinc, aluminum, cadmium, and alloys thereof, steel, stainless steel, and combinations thereof.

11. The method of claim 1, further comprising at least one additional process selected from the group consisting of:
(a) plating the substrate with zinc or zinc alloy to produce a plated substrate prior to coating the substrate with a non-chrome layer;
(b) oxidizing a surface of the substrate with an oxidizing agent prior to coating the substrate with a non-chrome layer; or (c) galvanizing the substrate prior to coating the substrate with a non-chrome layer.

12. A conversion coating composition comprising iron (II) ions, iron (III) ions, vanadium (V) ions, nitrate ions, and water, wherein said conversion coating composition is useful for coating a substrate with a black conversion coating.

13. The composition of claim 12, wherein the composition further comprises at least one additional component selected from the group consisting of vanadium (III), carboxylic acids, copper (II) ions, and combinations thereof.

14. The composition of claim 12, further comprising a strong acid selected from the group consisting of HCl, H₂SO₄, and combinations thereof.

15. The composition of claim 12, wherein the iron (III) to iron (II) ion weight ratio is in a range from about 1:1 to about 10:1.

16. The composition of claim 12, wherein the pH of said composition in a range from about 3 to about 7.

17. The composition of claim 12, wherein the cumulative nitrate to iron (III) ion weight ratio is in a range from about 1:1 to about 7:1.

18. The composition of claim 13, wherein the composition comprises iron (III) ions, iron (II) ions, vanadium (V) ions, nitrate ions, citrate ions, acetate ions, copper (II) ions, and water.

19. A method of coating a substrate with a black conversion coating, said method comprising contacting the substrate with the composition of any of claims 12 for sufficient time and under sufficient conditions for the deposition of a layer of black conversion coating on said substrate.

20. A method of manufacturing a corrosion-resistant article, said method comprising:
oxidizing a surface of the substrate with an oxidizing agent to produce an oxidized substrate;
coating the oxidized substrate with a non-chrome layer; and
coating the non-chrome layer with an secondary conversion or passivating layer, wherein the corrosion-resistant article includes the substrate, the non-chrome layer and the secondary conversion or passivating layer.

21. The method of claim 20, further comprising plating the substrate with zinc or zinc alloy prior to oxidizing the surface of the substrate.
